(19) United States
(12) Patent Application Publication
(10) Pub. No.: US 2026/0212473 A1
(43) Pub. Date: Jul. 23, 2026

(54) MULTI-DIMENSIONAL SMART SEMANTIC CONTRAST AND COLOR ENHANCEMENT

(71) Applicant: Samsung Electronics Co., Ltd., Suwon-si (KR)

(72) Inventors: Zeeshan Nadir, Allen, TX (US); Soumendu Majee, McKinney, TX (US); Hamid Rahim Sheikh, Allen, TX (US)

(21) Appl. No.: 19/441,677

(22) Filed: Jan. 6, 2026

Related U.S. Application Data
(60) Provisional application No. 63/747,541, filed on Jan. 21, 2025.

(51) Int. Cl. G06T 5/94; G06T 7/10

(52) U.S. Cl. CPC G06T 5/94; G06T 7/10

(57) ABSTRACT

A method includes obtaining, using at least one processing device of an electronic device, an image frame. The method also includes performing, using the at least one processing device, semantic segmentation of the image frame to generate semantic segmentation information for the image frame. The semantic segmentation information includes an indexed image representing at least a first semantic class and a second semantic class. The method further includes performing, using the at least one processing device, multi-scale local tone mapping of the indexed image using a first weight corresponding to the first semantic class and a second weight corresponding to the second semantic class. The first weight adapts enhancement of the image frame differently from the second weight based on a difference between the first semantic class and the second semantic class.

### CROSS-REFERENCE TO RELATED APPLICATION AND PRIORITY CLAIM

This application claims priority under 35 U.S.C. § 119 (e) to U.S. Provisional Patent Application No. 63/747,541 filed on Jan. 21, 2025, which is hereby incorporated by reference in its entirety.

### TECHNICAL FIELD

This disclosure relates generally image enhancement. More specifically, this disclosure relates to multi-dimensional smart semantic contrast and color enhancement.

### BACKGROUND

During image processing, contrast enhancement boosts pixel intensity differences to improve visibility, making details clearer. In general, optimal image contrast enhancement is difficult to perform in all areas of an image without introducing artifacts, such as stains (anomalous discolorations) or halos (bright or dark rims around edges). Often times, different parts of a scene within an image have conflicting contrast enhancement requirements. Tone mapping is another image processing technique and can be used to compress an image's range of light (dynamic range), but tone mapping also often requires different or conflicting color processing in one part of an image scene (such as a face or sky) than other parts of the image scene.

### SUMMARY

This disclosure relates to multi-dimensional smart semantic contrast and color enhancement.

In a first embodiment, a method includes obtaining, using at least one processing device of an electronic device, an image frame. The method also includes performing, using the at least one processing device, semantic segmentation of the image frame to generate semantic segmentation information for the image frame. The semantic segmentation information includes an indexed image representing at least a first semantic class and a second semantic class. The method further includes performing, using the at least one processing device, multi-scale local tone mapping of the indexed image using a first weight corresponding to the first semantic class and a second weight corresponding to the second semantic class. The first weight adapts enhancement of the image frame differently from the second weight based on a difference between the first semantic class and the second semantic class.

In a second embodiment, an electronic device includes at least one processing device configured to obtain an image frame. The at least one processing device is also configured to perform semantic segmentation of the image frame to generate semantic segmentation information for the image frame. The semantic segmentation information includes an indexed image representing at least a first semantic class and a second semantic class. The at least one processing device is further configured to perform multi-scale local tone mapping of the indexed image using a first weight corresponding to the first semantic class and a second weight corresponding to the second semantic class. The first weight adapts enhancement of the image frame differently from the second weight based on a difference between the first semantic class and the second semantic class.

In a third embodiment, a non-transitory machine readable medium contains instructions that when executed cause at least one processor of an electronic device to obtain an image frame and perform semantic segmentation of the image frame to generate semantic segmentation information for the image frame. The semantic segmentation information includes an indexed image representing at least a first semantic class and a second semantic class. The non-transitory machine readable medium also contains instructions that when executed cause the at least one processor to perform multi-scale local tone mapping of the indexed image using a first weight corresponding to the first semantic class and a second weight corresponding to the second semantic class. The first weight adapts enhancement of the image frame differently from the second weight based on a difference between the first semantic class and the second semantic class.

Any single one or any combination of the following features may be used with the first, second, or third embodiment.

Semantic segmentation may be performed by dividing an input luminance image corresponding to the image frame into multiple semantic classes including at least the first semantic class and the second semantic class.

A first bank of guided filters may be applied to the input luminance image to generate first base components and first detail components, and a second bank of guided filters may be applied to the first base components to generate second base components and second detail components.

Enhancement of the image frame may be performed by employing both the first weight corresponding to the first semantic class and the second weight corresponding to the second semantic class to adjust the first detail components and the second detail components.

Enhancement of the image frame may include one of increasing or decreasing contributions of the first detail components and the second detail components to an enhanced image based on the first semantic class and the second semantic class.

The enhanced image may be determined based on:

$$x = {B}_{2} + {w}_{1} ( M ) \times {D}_{1}^{′} + {w}_{2} ( M ) \times {D}_{2}^{′} ,$$

where x represents the enhanced image, B₂ represents the second base components, M represents the indexed image, w₁ represents the first weight corresponding to the first detail component, w₂ represents the second weight corresponding to the second detail component,

$${D}_{1}^{′}$$

represents the first detail components enhanced based on the first semantic class and the second semantic class, and

$${D}_{2}^{′}$$

represents the second detail components enhanced based on the first semantic class and the second semantic class.

Sharpness and contrast may be enhanced for the first detail components and the second detail components based on the first semantic class and the second semantic class.

Enhancement of the first detail components may include detail enhancement and noise suppression, and enhancement of the second detail components may include detail enhancement and bright area negative detail enhancement.

Enhancement of the first detail components and the second detail components may employ a modulation function that maps each of the first semantic class and the second semantic class to a corresponding modulation strength and a function processing positive details and negative details symmetrically in order to boost or suppress details based on distance from a specified value.

The modulation function S_{δ}_{₁} (M) mapping each of the first semantic class and the second semantic class to a modulation strength δ₁ may be applied to the first detail components, where M represents the indexed image as indexed based on the first semantic class and the second semantic class.

The modulation function S_{δ}_{₂} (M) mapping each of the first semantic class and the second semantic class to a modulation strength δ₂ may be applied to the second detail components, where M represents the indexed image as indexed based on the first semantic class and the second semantic class.

The modulation function S_{τ}(M) mapping each of the first semantic class and the second semantic class to a modulation strength t applied to the first detail components as a smooth step function with first and second thresholds, where M represents the indexed image as indexed based on the first semantic class and the second semantic class.

The semantic segmentation may be performed by dividing the image frame into multiple semantic classes including at least the first semantic class and the second semantic class. First color processing may be applied to portions of the image frame corresponding to the first semantic class, and second color processing may be applied to portions of the image frame corresponding to the second semantic class. Color enhancement of the image frame may be performed independently for colors of different semantic regions.

The first color processing may be associated with first hue shift or saturation boost values, and the second color processing may be associated with second hue shift or saturation boost values.

The multiple semantic classes may include semantic classes in addition to the first semantic class and the second semantic class.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IOT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration that may be employed for multi-dimensional smart semantic contrast and color enhancement in accordance with this disclosure;

FIG. 2 illustrates an example process for multi-dimensional smart semantic contrast and color enhancement in accordance with this disclosure;

FIG. 3 illustrates an example multi-frame image processing pipeline for multi-dimensional smart semantic contrast and color enhancement in accordance with this disclosure;

FIG. 4 illustrates an example tone mapping operation in FIG. 3 in accordance with this disclosure;

FIG. 5 illustrates an example multi-scale tone mapping (MSTM) function in FIG. 4 in accordance with this disclosure;

FIG. 6 illustrates examples of an input luminance image and associated base and detail components derived by the MSTM function in FIG. 4 in accordance with this disclosure;

FIG. 6A is an enlarged view of example first layer detail components in FIG. 6 in accordance with this disclosure;

FIG. 6B is an enlarged view of example second layer detail components in FIG. 6 in accordance with this disclosure;

FIG. 7 illustrates an example semantic segmentation of pixels of an image in FIGS. 6 and 6A-6B in accordance with this disclosure;

FIG. 8 illustrates application of an example modulation function to the image in FIGS. 6 and 6A-6B in accordance with this disclosure;

FIG. 9 illustrates an example graph of a sigmoid-similar function in accordance with this disclosure;

FIG. 10 illustrates an example graph of a smooth step function to avoid noise amplification in accordance with this disclosure;

FIG. 11 illustrates application of an example modulation function in FIG. 10 to the image in FIGS. 6 and 6A-6B in accordance with this disclosure;

FIGS. 12A through 13B illustrate application of example modulation functions to the image in FIGS. 6 and 6A-6B in accordance with this disclosure;

FIG. 14 illustrates another example tone mapping operation in FIG. 3 in accordance with this disclosure; and

FIG. 15 illustrates an example semantic segmentation of pixels of the image in FIGS. 6 and 6A-6B analogous to FIG. 7 in accordance with this disclosure.

### DETAILED DESCRIPTION

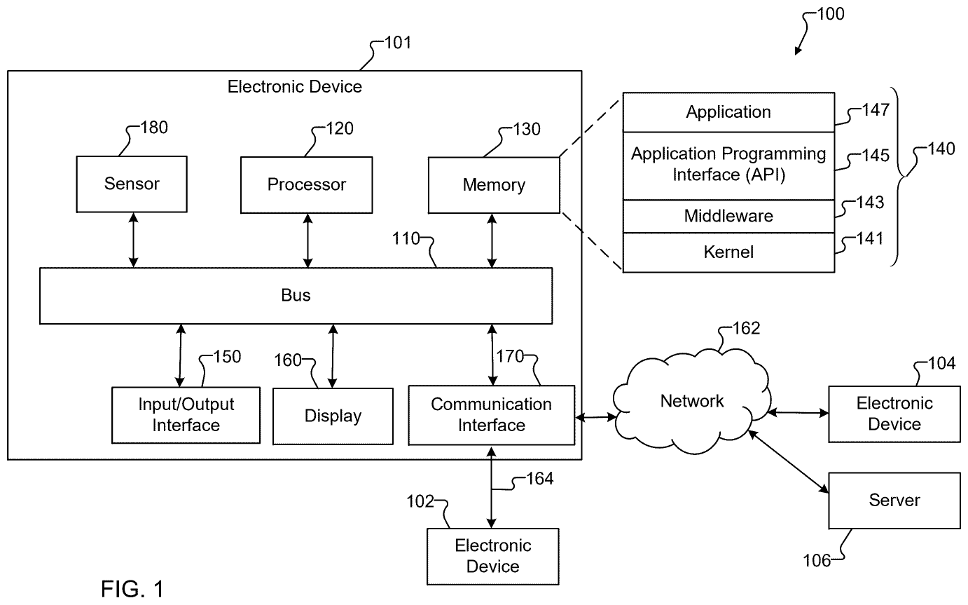

FIGS. 1 through 15, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, during image processing, contrast enhancement boosts pixel intensity differences to improve visibility, making details clearer. In general, optimal image contrast enhancement is difficult to perform in all areas of an image without introducing artifacts, such as stains (anomalous discolorations) or halos (bright or dark rims around edges). Often times, different parts of a scene within an image have conflicting contrast enhancement requirements. Tone mapping is another image processing technique and can be used to compress an image's range of light (dynamic range), but tone mapping also often requires different or conflicting color processing in one part of an image scene (such as a face or sky) than other parts of the image scene.

This disclosure provides various techniques for multi-dimensional smart semantic contrast and color enhancement. As described in more detail below, an image frame can be obtained, and semantic segmentation of the image frame can be performed to generate semantic segmentation information for the image frame. The semantic segmentation information can include an indexed image representing at least a first semantic class and a second semantic class. Multi-scale local tone mapping of the indexed image can be performed using a first weight corresponding to the first semantic class and a second weight corresponding to the second semantic class. The first weight can adapt enhancement of the image frame differently from the second weight based on a difference between the first semantic class and the second semantic class.

In this way, the described techniques can be used to address shortcomings of typical tone mapping operations, such as the problem of conflicting image enhancement requirements in different parts of a scene within an image. As a result, an improved local tone mapping operation can be provided using semantic information. For example, smart semantic contrast enhancement as described here can utilize semantic information and multi-scale, filter bank-based decomposition. This can solve the problem of conflicting contrast enhancement requirements in different parts of a scene. With these approaches, for instance, contrast can be enhanced optimally in one part of an image without introducing stains, halos, or other artifacts in other parts. As another example, smart semantic color processing could utilize semantic information to perform optimal color processing for each semantic class in a scene, such as when semantic segmentation allows changing of colors in each semantic region independently based on calibrated or tuned shifts. Thus, for example, color processing could be performed in red-green-blue (RGB); brightness (luma) and color (chroma blue and chroma red) (YUV); hue, saturation, and value (HSV); or other color spaces. Each semantic class may have its own hue shift or saturation boost values (which could be dependent on image metadata), which may be calibrated based on desirable colors in reference images and fine-tuned. With these approaches, colors of different semantic regions of an image can be enhanced independently without conflicting with other semantic regions.

FIG. 1 illustrates an example network configuration 100 that may be employed for multi-dimensional smart semantic contrast and color enhancement in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to multi-dimensional smart semantic contrast and color enhancement.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to multi-dimensional smart semantic contrast and color enhancement. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensor(s) 180 that can meter a physical quantity or detect an activation state of the electronic device 101 and convert metered or detected information into an electrical signal. For example, one or more sensor(s) 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an extended reality (XR) device, which includes a virtual reality (VR) headset or an augmented reality (AR) wearable device, such as eyeglasses that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to multi-dimensional smart semantic contrast and color enhancement.

Although FIG. 1 illustrates one example of a network configuration 100 that may be employed for multi-dimensional smart semantic contrast and color enhancement, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

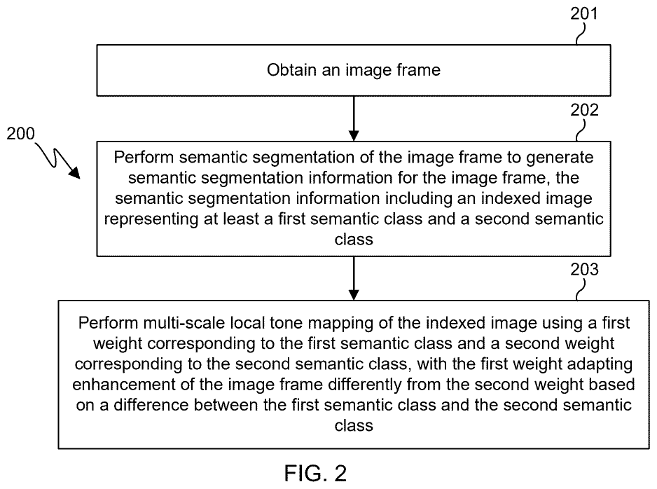

FIG. 2 illustrates an example process 200 for multi-dimensional smart semantic contrast and color enhancement in accordance with this disclosure. For ease of explanation, the process 200 of FIG. 2 is described as being performed using the electronic device 101 in the network configuration 100 of FIG. 1. However, the process 200 may be performed using any other suitable device(s) (such as the server 106) and in any other suitable system(s).

As shown in FIG. 2, the process 200 includes obtaining an image frame (step 201). In some cases, the image frame may be derived using multiple image frames captured by one or more cameras on an electronic device, such as one or more imaging sensors 180 of the electronic device 101. As a particular example, the image frame could be generated by performing image fusion during high dynamic range (HDR) generation, multi-focus fusion, or other image processing operation.

Semantic segmentation of the image frame is performed to generate semantic segmentation information for the image frame (step 202). The semantic segmentation information includes an indexed image representing at least a first semantic class and a second semantic class. In some cases, the semantic segmentation may involve the processor 120 of the electronic device 101 dividing an input luminance image corresponding to the image frame into multiple semantic classes including at least the first semantic class and the second semantic class. As a particular example, during the semantic segmentation, a first bank of guided filters may be applied to an input luminance image to generate first base components and first detail components, and a second bank of guided filters may be applied to the first base components to generate second base components and second detail components.

Multi-scale local tone mapping of the indexed image is performed using a first weight corresponding to the first semantic class and a second weight corresponding to the second semantic class (step 203). The first weight adapts enhancement of the image frame differently from the second weight based on a difference between the first semantic class and the second semantic class. For example, enhancement of the image frame may employ both the first weight corresponding to the first semantic class and the second weight corresponding to the second semantic class to adjust the first detail components and the second detail components. As a particular example, enhancement of the first detail components and the second detail components may employ a modulation function that maps each of the first semantic class and the second semantic class to a corresponding modulation strength and a function processing positive details and negative details symmetrically in order to boost or suppress details based on distance from a specified value.

Although FIG. 2 illustrates one example of a process 200 for multi-dimensional smart semantic contrast and color enhancement, various changes may be made to FIG. 2. For example, while shown as a series of steps, various steps in FIG. 2 could overlap, occur in parallel, occur in a different order, or occur any number of times (including zero times).

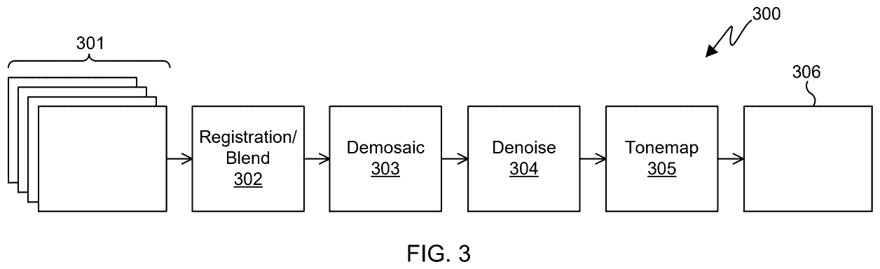

FIG. 3 illustrates an example multi-frame image processing pipeline 300 for multi-dimensional smart semantic contrast and color enhancement in accordance with this disclosure. For ease of explanation, the pipeline 300 of FIG. 3 is described as being implemented using the electronic device 101 in the network configuration 100 of FIG. 1, which could implement the process 200 of FIG. 2. However, the pipeline 300 may be implemented within any other suitable device(s) (such as the server 106) and in any other suitable system(s), and the pipeline 300 may be used to implement any other suitable process(es).

As shown in FIG. 3, the pipeline 300 receives multiple input image frames 301 to be processed, such as image frames captured using the imaging sensor(s) 180 of the electronic device 101. The pipeline 300 performs one or more image processing operations on the image frames 301, such as a registration and blending operation 302 in which the image frames 301 are aligned with one another and pixel data from the image frames 301 is combined in some manner during blending. The output of the registration and blending operation 302 is processed using a demosaicing operation 303 in which a full color image is reconstructed and a denoising operation 304 to improve clarity, quality, and detail.

At the end of the pipeline 300, a tone mapping operation 305 is performed as described in further detail below to generate a final output image 306. The tone mapping operation 305 can compress a higher dynamic range to a smaller dynamic range, thus yielding a low dynamic range (LDR) final output image 306 that is suitable for viewing on displays (such as the display 160 of the electronic device 101) and/or print media. In some cases, the tone mapping operation 305 can be useful because the result of prior operations in the pipeline 330 can include HDR image data having unnatural tones. While local and global tone mapping operations in the tone mapping operation 305 can be adjusted to enhance contrast in the final output image 306, contrast enhancement performed during tone mapping can frequently cause stains, halos, and other artifacts. The techniques described below help to reduce or eliminate these artifacts.

Although FIG. 3 illustrates one example of a pipeline 300 for multi-frame image processing using multi-dimensional smart semantic contrast and color enhancement in accordance with this disclosure, various changes may be made to FIG. 3. For example, various components or functions in FIG. 3 may be combined, further subdivided, replicated, omitted, or rearranged and additional components or functions may be added according to particular needs. Also, while shown as a series of operations, image processing may be performed at least partially in parallel, or portions of the image processing may be performed in an integrated fashion.

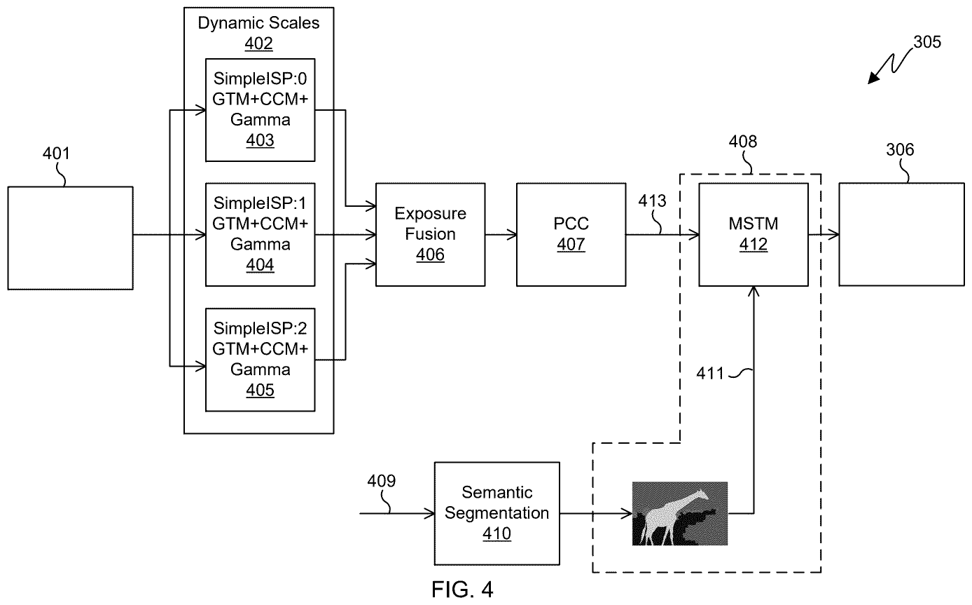

FIG. 4 illustrates an example tone mapping operation 305 in FIG. 3 in accordance with this disclosure. For ease of explanation, the tone mapping operation 305 in FIG. 4 is described as being implemented using the pipeline 300 of FIG. 3 and performed by the processor 120 of the electronic device 101 in the network configuration 100 of FIG. 1. However, the tone mapping operation 305 may be implemented within any other suitable pipeline(s) or device(s).

As shown in FIG. 4, the tone mapping operation 305 receives a tone map input 401 and performs a series of functions. In some cases, the tone map input 401 may represent an output of the denoising operation 304 in the pipeline 300 of FIG. 3 or any other suitable image process. Here, the tone map input 401 is passed to a dynamic scales function 402, which may be implemented using an array of image signal processors 403-405 in the example shown. Each of the image signal processors 403-405 may operate using a global tone map (GTM) to provide overall tonal control, a color correction matrix (CCM) to adjust colors to a standard color space, and gamma correction to adjust image brightness (such as midtones) to compensate for non-linear responses of a display device.

An exposure fusion function 406 receives the outputs of the image signal processors 403-405 and fuses multiple exposures, such as to provide dynamic range compression. A preferential color correction (PCC) function 407 applies one or more look-up tables (LUTs) to hues and saturation values, such as to shift colors in a desired direction. Each of the dynamic scales function 402, exposure fusion function 406, and PCC function 407 may use any of well-known processes or later-developed processes to perform their respective functions.

The tone mapping operation 305 in FIG. 4 also includes a segmentation-based image contrast enhancement function 408, which processes a segmented version of an input image frame 409 provided by a semantic segmentation function 410. The input image frame 409 may correspond to raw image data, RGB image data, processed image data, unprocessed image data, or other suitable image data. Any of a variety of semantic segmentation techniques may be employed by the semantic segmentation function 410, such as “Segment Anything,” YOLOv8, and the like. In some embodiments, the semantic segmentation function 410 classifies each pixel in the input image frame 409 into one of a number of predefined categories, such as “sky,” “face,” etc., attaching an associated semantic class.

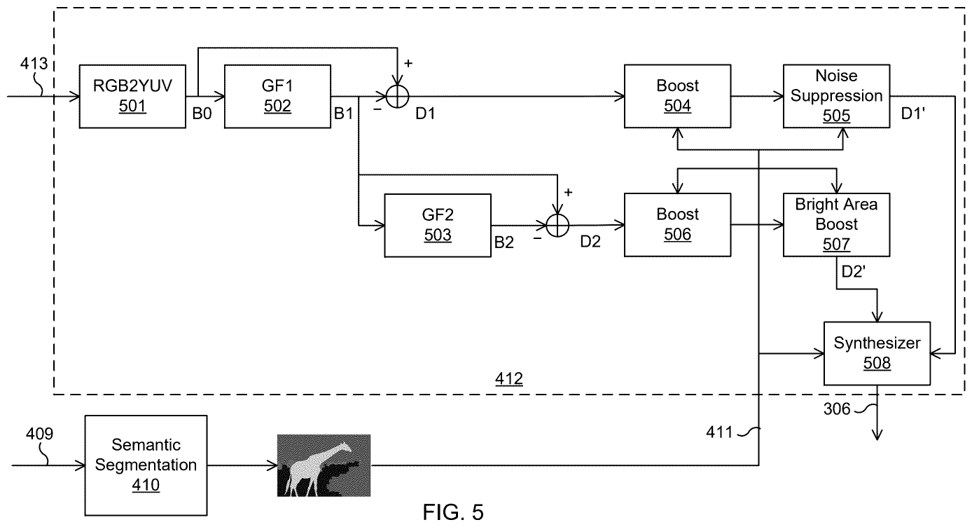

The semantic classes 411 output by the semantic segmentation function 410 are employed by a local multi-scale tone map (MSTM) function 412 of the image contrast enhancement function 408. The MSTM function 412 can perform tone mapping on an RGB input image 413 (such as RGB or other image data) that is output from the PCC function 407. A specific example implementation of the MSTM function 412 is described below in connection with FIG. 5.

The segmentation-based image contrast enhancement function 408 can perform a smart semantic-based contrast enhancement that utilizes semantic information and multi-scale filter bank-based or other decomposition. This approach solves problems related to conflicting contrast enhancement requirements in different parts of a scene. Example benefits can include allowing contrast to be enhanced differently (such as optimally) in one part of an image frame without introducing artifacts (such as stains, halos, etc.) in other parts of the image frame. The output of the MSTM function 412 may represent the final output image 306 of the pipeline 300 in FIG. 3.

Although FIG. 4 illustrates one example of the tone mapping operation 305 in FIG. 3, various changes may be made to FIG. 4. For example, various components or functions in FIG. 4 may be combined, further subdivided, replicated, omitted, or rearranged and additional components or functions may be added according to particular needs. Also, any suitable number of image signal processors may operate in parallel on a tone map input, such as when each operates on a different region of the tone map input or each operates on a different logical portion (such as color) of the tone map input.

FIG. 5 illustrates an example MSTM function 412 in FIG. 4 in accordance with this disclosure. For ease of explanation, the MSTM function 412 of FIG. 5 is described as being implemented as part of the tone mapping operation 305 within the pipeline 300 of FIG. 3, which may be implemented using the processor 120 of the electronic device 101 in the network configuration 100 of FIG. 1. However, the MSTM function 412 may be implemented within any other suitable operation(s), pipeline(s), device(s), or system(s).

As shown in FIG. 5, the MSTM function 412 can represent a local tone mapping operation that uses multi-dimensional decomposition based on filter banks and semantic segmentation. In this example, a converter function 501 converts (if necessary) the RGB input image 413 to another image format, such as the YUV format, to obtain an input luminance image B₀. The semantic segmentation function 410 can be employed to divide the input luminance image B₀ into multiple class instances of semantic classes 411.

A first guided filter bank 502 (GF1) and a second guided filter bank 503 (GF2) can be used to generate different hierarchical components. For example, the guided filter bank 502 can generate base components B₁ from the input luminance image B₀, and the guided filter bank 503 can generate base components B₂ from the base components B₁. The input luminance image B₀ and the base components B₁ generated by the guided filter bank 502 can be used to generate detail components D₁ as D₁=B₀−B₁. The base components B₁ generated by the guided filter bank 502 and the base components B₂ generated by the guided filter bank 503 can be used to generate detail components D₂=B₂−B₁.

A detail enhancement boost function 504 and a noise suppression function 505 can use semantic segmentation information from the semantic segmentation function 410 to enhance sharpness and contrast of the detail components D₁. Similarly, a detail enhancement boost function 506 and a bright area boost function 507 can use semantic segmentation information from the semantic segmentation function 410 to enhance sharpness and contrast of the detail components D₂. In some cases, the functions 504-507 can include adjustments of sharpness and contrast strength settings for each of the semantic classes 411, base components B₁ and B₂, and detail components D₁ and D₂. Contrast and sharpness enhancement for each component could be based on these sharpness and contrast strength settings, producing enhanced detail components

$${D}_{1}^{′} and {D}_{2}^{′} .$$

An image synthesizer function 508 determines a weighted sum of the base components B₁ and B₂ and the enhanced detail components

$${D}_{1}^{′} and {D}_{2}^{′} .$$

in some cases, weights used to calculate the weighted sum can be a function of the semantic classes 411 within the semantic segmentation map and can be selected to increase/decrease the contributions of the enhanced detail components

$${D}_{1}^{′} and {D}_{2}^{′}$$

based on the semantic classes 411 to produce a final output image 306. In some embodiments, the final output image (x) 306 may be defined as follows.

$$x = {B}_{2} + {w}_{1} ( M ) \times {D}_{1}^{′} + {w}_{2} ( M ) \times {D}_{2}^{′} \qquad ( 1 )$$

Here, × indicates pointwise multiplication, M represents an indexed image 411 identifying different sematic classes, and w₁, w₂ represent the weights, which could be a function of the semantic classes. As a particular example, “sky” and “grass” semantic classes may have higher weights but a “face” semantic class may have a lower weight, which can be done to maximize contrast for “sky” and “grass” image content and keep contrast lower for “face” image content.

With respect to the guided filter bank 502 and the guided filter bank 503, each guided filter could represent an edge-preserving filter that can filter out noise and details in an input image while preserving strong edges in the image. Any suitable guided filter operation can be used here. In this disclosure, G_{r,ε}(P, I) is used to represent a guided filtering operation, where r and ε are parameters that decide the filter size and blur degree of the guided filter, P is a guide image, and I is an input image to the guided filter. Decomposition can include a coarse and low-pass version of an image (B₂ in FIG. 5), along with a sequence of difference images capturing details at progressively finer scales (D₁, D₂ in FIG. 5).

As an example of how the guided filter bank 502 or the guided filter bank 503 may operate, assume that B₀ is an input luminance image. Let B₁, . . . , B_{K} denote progressively coarser versions of the input luminance image generated by guided filter operation G_{r,ε}(P, I), which could be defined as follows.

$${B}_{k} = {G}_{r , ε} ( {B}_{k - 1} , {B}_{k - 1} ) , k = 1 , … , K \qquad ( 2 )$$

With the coarsest base components B_{K} serving as the base layer, the detail layers D₁, . . . , D_{K} could be defined as follows.

$${D}_{k} = {B}_{k - 1} - {B}_{k} , k = 1 , … , K \qquad ( 3 )$$

In the specific implementation in FIG. 5, K=2. Example values of other parameters could include r₁=3, ε₁=0.001, r₂=8, and ε₂=0.001. Increasing r₁ and ε₁ can result in a detail component D₁ that has more high-frequency details and thus more detail enhancement. Increasing r₂ and ε₂ can result in a detail component D₂ that has more high-frequency details and thus more detail/contrast enhancement. To obtain more contrast enhancement, r₂ and ε₂ can be increased. In particular embodiments, a good choice for sharpening and contrast enhancement in typical images could be to make r₂>r₁ and ε₂>ε₁.

In some cases, the detail components D₁ may capture finer details and noise, thus providing the ability to suppress noise amplification in this layer. Also, in some cases, the detail components D₂ may include larger-scale details (such as local tone information), which can be suitable for contrast enhancement.

Although FIG. 5 illustrates one example of the MSTM function 412 in FIG. 4, various changes may be made to FIG. 5. For example, various components or functions in FIG. 5 may be combined, further subdivided, replicated, omitted, or rearranged and additional components or functions may be added according to particular needs. Also, while FIG. 5 includes two guided filter banks, any number of guided filters can be used, and the description here provides generalizations that contemplate the use of any number of guided filters to perform multi-dimensional decomposition.

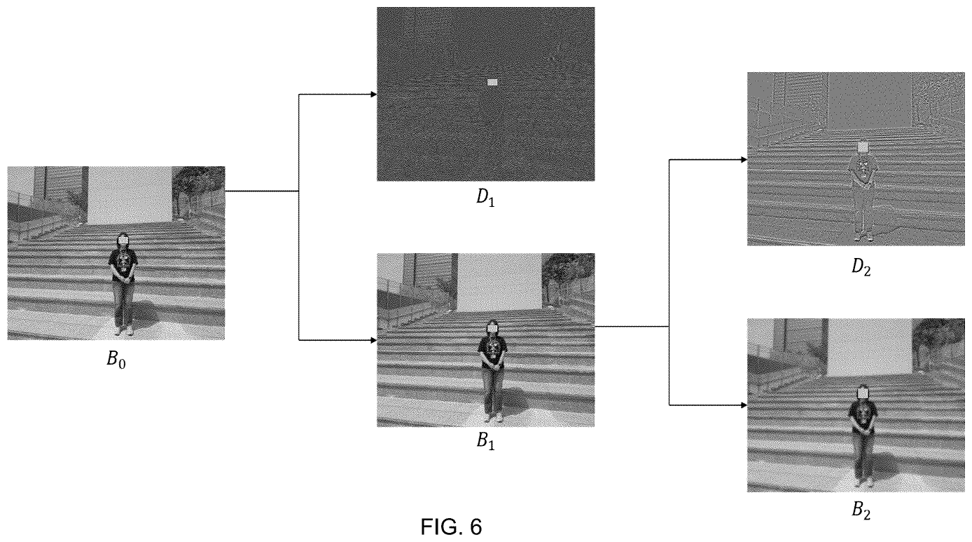

FIG. 6 illustrates examples of an input luminance image B₀ and associated base and detail components B₁-B₂, D₁-D₂ derived by the MSTM function 412 in FIG. 4 in accordance with this disclosure. FIG. 6A is an enlarged view of example first layer detail components D₁ in FIG. 6 in accordance with this disclosure, and FIG. 6B is an enlarged view of example second layer detail components D₂ in FIG. 6 in accordance with this disclosure.

Referring back to FIG. 5, the detail enhancement boost functions 504 and 506 can use semantic segmentation information to enhance sharpness and contrast of respective component images (first layer detail components D₁ and second layer detail components D₂). In some embodiments, the detail enhancement boost functions 504 and 506 may modify fine-scale details using a sigmoid-similar function, which could be expressed as follows.

$${D}_{1} m = {f}_{s} ( {δ}_{1} , {D}_{1} \times {S}_{{δ}_{1}} ( M ) ) = 2 \times arctan ( {δ}_{1} \times {D}_{1} \times {S}_{{δ}_{1}} ( M ) ) / π \qquad ( 4 )$$

Here, M represents the indexed image 411 identifying different sematic classes 411, S& is a modulation function that maps each of the semantic classes 411 to a corresponding modulation strength δ₁, and fₛ is a function that symmetrically processes positive and negative details (such as by boosting details around zero and suppressing details close to one). In particular embodiments, the modulation function Ss, can be arbitrary and can be tuned to meet visual or image quality requirements.

As shown in FIGS. 6 and 6A-6B, an input luminance image B₀ captures a scene including a person (whose face is obscured for privacy). The input luminance image B₀ can be used to generate a base layer B₁ and a detail layer D₁. The base layer B₁ can be used to generate a base layer B₂ and a detail layer D₂. Additional decompositions may be possible to generate additional base layers and detail layers.

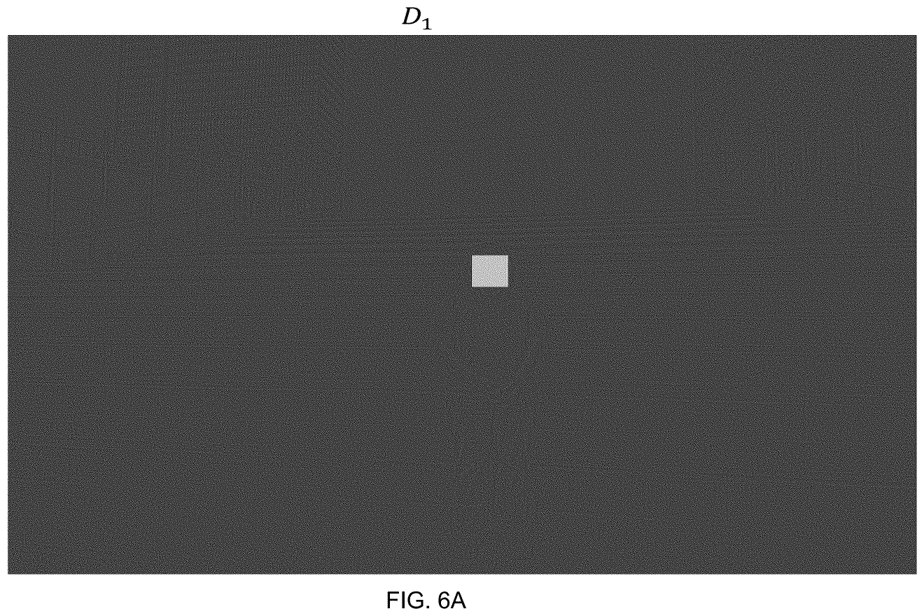

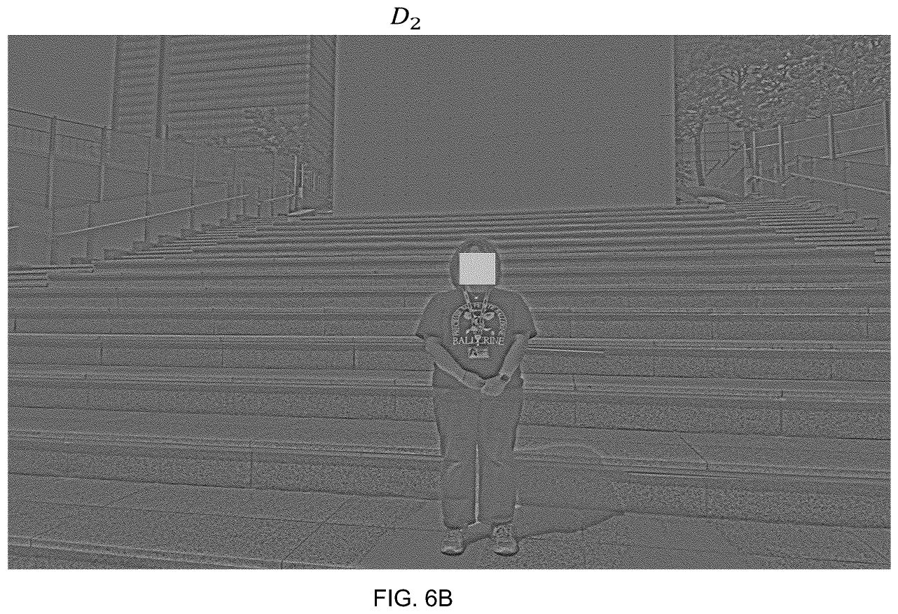

FIG. 7 illustrates an example semantic segmentation of pixels of an image in FIGS. 6 and 6A-6B in accordance with this disclosure. As can be seen here, the semantic segmentation divides the image into multiple semantic classes 411, such as person, sky, foliage, building/construction structure, and background. Note that the specific semantic classes 411 shown here are examples only and could vary depending on the implementation. FIG. 8 illustrates application of an example modulation function Ss, to the image in FIGS. 6 and 6A-6B in accordance with this disclosure. The modulation strength &1 for different semantic classes 411 is shown on the right in FIG. 8.

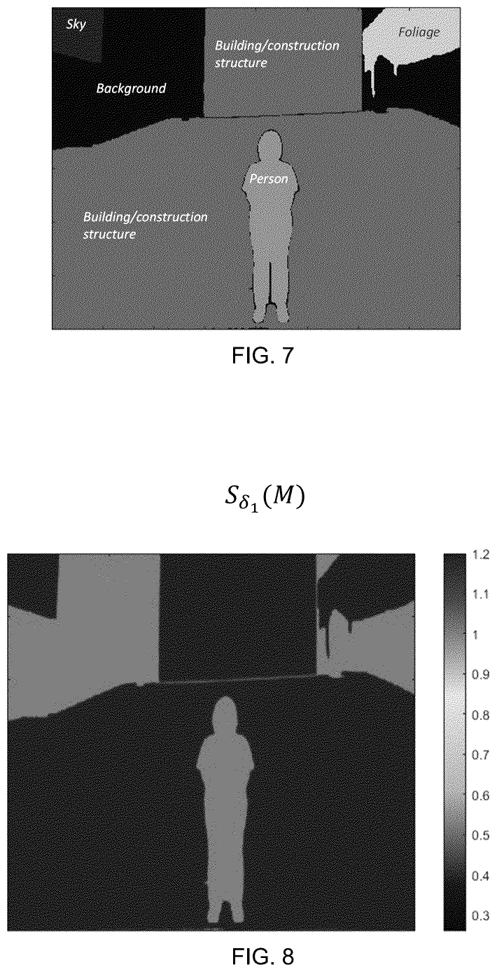

FIG. 9 illustrates an example graph 900 of a sigmoid-similar function in accordance with this disclosure. The sigmoid-similar function (denoted fₛ in Equation (4)) can be defined as a plot of enhanced details as a function of image details. In the graph 900, a curve 901 represents a straight line with a slope of one, while a curve 902 represents the sigmoid-similar function. In some cases, the sigmoid-similar function may be defined as follows.

$$f ( x , {δ}_{1} ) = \frac{2 \times arctan ( {δ}_{1} 3 x )}{π} , x = - 1 … 1 \qquad ( 5 )$$

A curve 903 illustrates that an amplitude of the sigmoid-similar function may be made larger or smaller by making δ₁ larger or smaller.

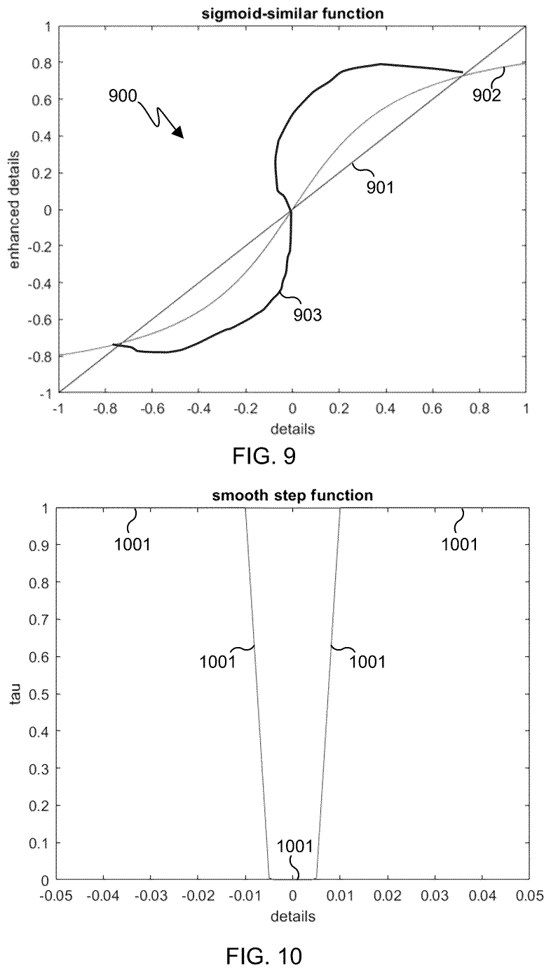

FIG. 10 illustrates an example graph 1000 of a smooth step function to avoid noise amplification in accordance with this disclosure. One characteristic of using a sigmoid-similar function is that other functions could make noise and artifacts more visible. This issue can be mitigated by limiting the smallest details that are amplified, such as by using a sigmoid-similar function having the following form.

$${D}_{1}^{′} = {S}_{τ} ( M ) \times τ \times {D}_{1} m + ( 1 - τ ) \times {S}_{τ} ( M ) \times {D}_{1} \qquad ( 6 )$$

Here, τ is a smooth step function equal to zero if D₁ is less than a first threshold thr₁ and equal to one if D₁ is more than a second threshold thr₂, where a smooth linear transition is between the two. A modulation function Sr can map each of the semantic classes 411 to a modulation strength for τ. With reference to FIG. 5, D₁ can represent the input to the detail enhancement boost function 504, D₁m can represent the output of the detail enhancement boost function 504 and the input to the noise suppression function 505, and D₁′ can represent the output of the noise suppression function 505. One particular example expression for a smooth step function may be defined as follows.

$$τ = 0 * ( \vert {D}_{1} \vert < {thr}_{1} ) + 1 * ( \vert {D}_{1} \vert > t h {r}_{2} ) + ( \frac{\vert {D}_{1} \vert - t h {r}_{1}}{t h {r}_{2} - t h {r}_{1}} + t h {r}_{1} ) * ( \vert {D}_{1} \vert \geq t h {r}_{1} \& \vert {D}_{1} \vert \leq th {r}_{2} ) \qquad ( 7 )$$

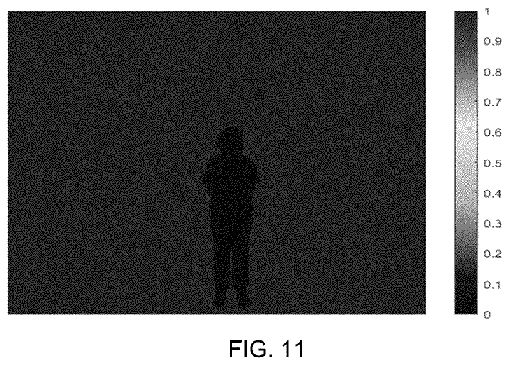

In particular embodiments, example values of the parameters could include δ₁=0.25, thr₁=0.005, and thr₂=0.01. In some instances, these parameters can be chosen so that thr₂>thr₁, with the understanding that a larger thr₁ results in less noise enhancement. One example smooth step function to avoid noise amplification is shown in FIG. 10, with thr₁=0.005 and thr₂=0.01. FIG. 11 illustrates application of an example modulation function in FIG. 10 to the image in FIGS. 6 and 6A-6B in accordance with this disclosure. Again, modulation strength τ for different semantic classes 411 are shown on the right in FIG. 11.

Referring back to FIG. 5, in some embodiments, contrast and local tone of an image may be enhanced by manipulating the layer of detail components D₂. In some cases, the detail components D₂ could include large-scale edges and some flat regions. Contrast and local tone enhancement of the detail components D₂ could occur using a similar function fₛ, which could be expressed as follows.

$${D}_{2} m = {f}_{s} ( {D}_{2} , 2 \times {S}_{{δ}_{2}} ( M ) ) = 2 \times arctan ( {δ}_{2} \times {D}_{2} \times {S}_{{δ}_{2}} ( M ) ) / π \qquad ( 8 )$$

Here, M represents the indexed image 411 identifying different sematic classes, S_{δ}_{₂} is a modulation function that maps each of the semantic classes to a corresponding modulation strength δ₂, and fₛ is a function that symmetrically processes positive and negative details (such as by boosting details around zero and suppressing details close to one). In some cases, the function fₛ may represent a sigmoid-similar function. With reference to FIG. 5, D₂ can represent the input to the detail enhancement boost function 506, D₂m can represent the output of the detail enhancement boost function 506 and the input to the bright area boost function 507, and

$${D}_{2}^{′}$$

can represent the output of the bright area boost function 507. In particular embodiments, the modulation function Ss, can be arbitrary and can be tuned to meet visual or image quality requirements.

In this example, the parameter 82 can control the contrast level. If 82 is too small, the entire image may look flat. If 82 is too large, the entire image may be over-contrasted, and halo artifacts can be more severe. Often times, bright areas within an image can suffer from low contrast issues giving a hazy appearance more than darker areas, so the bright area boost function 507 can be used to increase the contrast of bright areas. As boosting the positive details of bright areas can lead to a loss of saturation details, only negative details in the base components B₂ could be enhanced. In some cases, a bright area may be identified in the following manner.

$$Bmap = {e}^{- \frac{{( {B}_{2} - 1. )}^{2}}{2 {σ}^{2}}} \qquad ( 10 )$$

$${D}_{2}^{′} = {D}_{2} m + {f}_{s} ( {D}_{2} , {δ}_{3} ) * ( {D}_{2} < 0 ) \qquad ( 11 )$$

In some embodiments, an example parameter selection may be σ=0.3, δ₂=2, and δ₃=4.

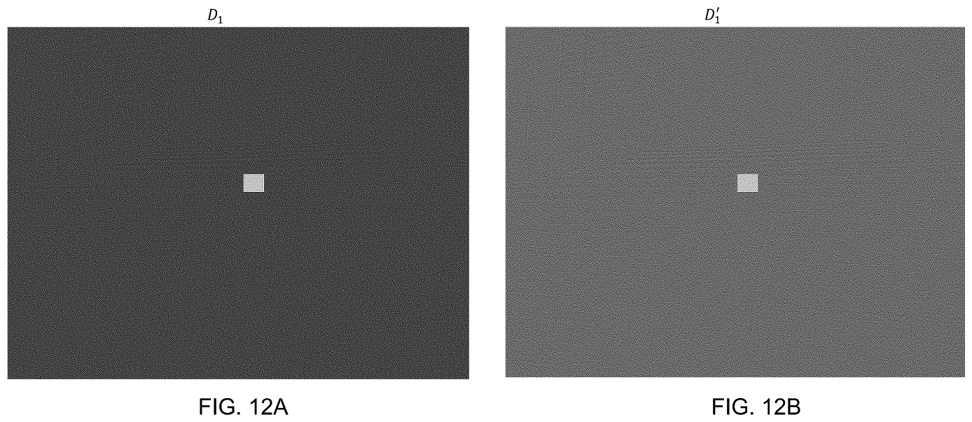

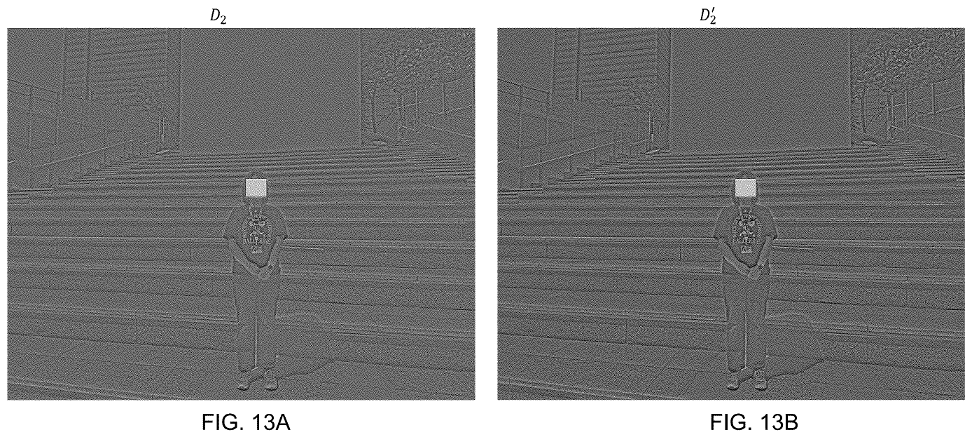

FIGS. 12A through 13B illustrate application of example modulation functions to the image in FIGS. 6 and 6A-6B in accordance with this disclosure. More specifically, FIG. 12A illustrates the detail component D₁, and FIG. 12B illustrates the enhanced detail components

$${D}_{1}^{′} .$$

Similarly, FIG. 13A illustrates the detail component D₂, and FIG. 13B illustrates the enhanced detail components

$${D}_{2}^{′} .$$

Although FIGS. 6 through 13B illustrate examples of images and processing results, various changes may be made to FIGS. 6 through 13B. For example, the specific images being processed can vary widely based on the circumstances. Also, the specific processing results shown here are examples only and are merely meant to illustrate how various operations or functions may be performed.

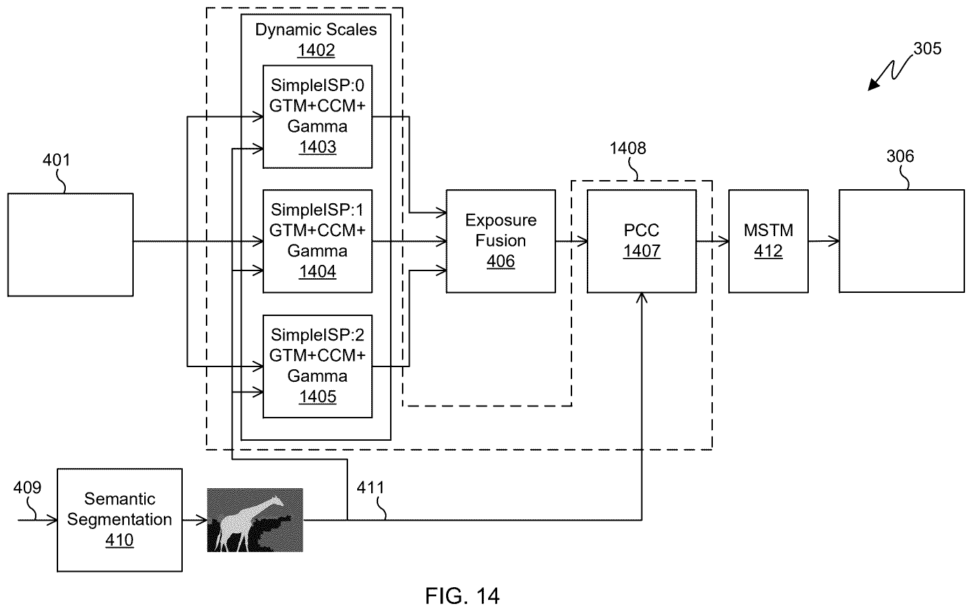

FIG. 14 illustrates another example tone mapping operation 305 in FIG. 3 in accordance with this disclosure. For ease of explanation, the tone mapping operation 305 in FIG. 14 is described as being implemented using the pipeline 300 of FIG. 3 and performed by the processor 120 of the electronic device 101 in the network configuration 100 of FIG. 1. However, the tone mapping operation 305 may be implemented within any other suitable pipeline(s) or device(s).

The tone mapping operation 305 of FIG. 14 is similar to the tone mapping operation 305 of FIG. 4. However, in FIG. 14, a segmentation-based image contrast enhancement function 1408 includes both a dynamic scales function 1402 and a PCC function 1407 that operate based on semantic classes. Here, the dynamic scales function 1402 includes image signal processors 1403-1405. The image signal processors 1403-1405 and the PCC function 1407 can operate utilizing semantic information to perform optimal color processing for each semantic class in a scene. For instance, semantic segmentation can be used to support a color correction matrix used by the image signal processors 1403-1405 and the PCC function 1407 to change colors in each semantic region independently based on calibrated or tuned shifts.

As in FIG. 4, color processing in FIG. 14 can be performed in the RGB, YUV, HSV, or other color spaces. However, in FIG. 14, each semantic class 411 could have its own hue shift or saturation boost values (which could be dependent on image metadata), which can be calibrated based on desirable colors in reference images and fine-tuned. One benefit of this approach is that the colors of different semantic regions of an image can be enhanced independently without conflicting with other semantic regions.

As a particular example, tone mapping in FIG. 14 could be performed using semantic segmentation to change the color of each semantic region independently. For example, assume the following. A hue look-up table (LUT) Hᵢ: [0,1]×[0,1]=> [0,1] is a look-up table that transforms points in hue, saturation coordinates to new hue values for a semantic class i. A saturation look-up table Sᵢ: [0,1]×[0,1]=> [0,1] is a look-up table that transforms points in hue, saturation coordinates to new saturation values for a semantic class i. For processing in the HSV color space, hue/saturation can be obtained directly. For processing in the YUV color space, approximate hue can be obtained by

$${tan}^{- 1} ( \frac{V}{U} ) ,$$

and approximate saturation can be obtained by \sqrt{U²+V²}, where U and V are the YUV chroma values. For processing in other color spaces, similar approximate hue/saturation could be obtained.

Based on the above, given an image I(x), the following could be performed by the PCC function 1407. Hue/saturation values Hᵢ(x) and Sᵢ(x) can be determined for each pixel location x, and the segmentation map M(x)∈[0, . . . , c] can be determined. For each pixel location x, transformed hue/saturation values H_{M(x)}(x) and S_{M(x)}(x) can be calculated, and transformed hue/saturation values can be combined with original luminance values to generate a final image. Further, to obtain a smooth transition in color appearance between pixels that fall across the boundary of different semantic classes, interpolation or other techniques could be used.

Note that hue/saturation adjustments using one or more LUTs could add extra computational overhead. In other embodiments, semantic color processing with minimal extra computational overhead may be achieved, such as by modulating the application of the CCM using the semantic segmentation. Accordingly, in FIG. 14, for CCM by the image signal processors 1403-1405, the following can be introduced. Hue CCM matrices Cᵢ can each represent a 3×3 or other CCM for semantic class i. Based on the above, given an image I(x), the following could be performed by each of the image signal processors 1403-1405. A segmentation map M(x)∈[0, . . . , c] can be determined, and a CCM operation C_{M(x)}I(x) can be performed for each pixel location x. Further, to obtain a smooth transition in color appearance between pixels that fall across the boundary of different semantic classes, interpolation or other techniques could be used.

Although FIG. 14 illustrates another example of the tone mapping operation 305 in FIG. 3, various changes may be made to FIG. 14. For example, various components or functions in FIG. 14 may be combined, further subdivided, replicated, omitted, or rearranged and additional components or functions may be added according to particular needs. Also, any suitable number of image signal processors may operate in parallel on a tone map input, such as when each operates on a different region of the tone map input or each operates on a different logical portion (such as color) of the tone map input.

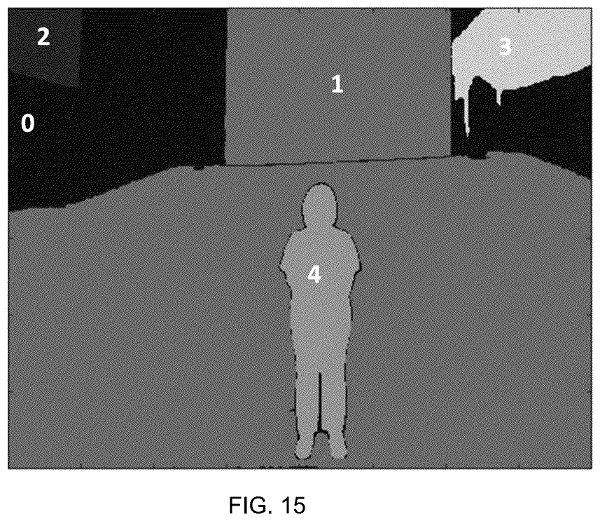

FIG. 15 illustrates an example semantic segmentation of pixels of the image in FIGS. 6 and 6A-6B analogous to FIG. 7 in accordance with this disclosure. Here, class labels zero through four are used to denote different semantic classes 411. For segmentation-based CCM and PCC as shown in FIG. 14, the following could be used based on the segmentation map.

| Class Label | PCC Tables | CCM Matrix |
|---|---|---|
| 0 | PCC Table 0 | CCM Matrix 0 |
| 1 | PCC Table 1 | CCM Matrix 1 |
| 2 | PCC Table 2 | CCM Matrix 2 |
| 3 | PCC Table 3 | CCM Matrix 3 |
| 4 | PCC Table 4 | CCM Matrix 4 |

In other words, there can be different PCC tables and/or different CCM matrices for different semantic classes 411.

In some embodiments, operations within the tone mapping operation 305 of FIG. 14 may occur in the following manner. For segmentation-based CCM without interpolation, the following may be performed:

```
For each exposure level EVₖ
  For each pixel pᵢ
    Label = S(i)
    Apply CCM Matrix (Label) on pᵢ
  End For
End For
```

For segmentation-based PCC without interpolation, the following may be performed:

```
For each pixel pᵢ in PCC input image
  Label = S(i)
  Apply PCC Matrix (Label) on pᵢ
End For
```

For segmentation-based PCC with interpolation, using the first two columns of the table above, the following may be performed:

```
For each label k ∈ {0, 1, ... , K}
  Lₖ = Binary Mask corresponding to label k
  L′ₖ = Low Pass Filter (L′ₖ)
End For
For each pixel pᵢ in PCC input image:
  output(i) = 0
  normConst = 0
  Label = S(i)
  For each label k ∈ {0, 1, ... , K}
    output(i) = Apply PCC (Label) on pᵢ * L′ₖ(i)
    normConst = normConst + L′ₖ(i)
  End For
  output(i) = output(i)/normConst
End For
```

Semantic control of contrast can provide improved results, such as better background contrast or reduced face stains, relative to traditional contrast enhancement. Semantic control of color enhancement can also provide improved results, such as reduced occurrences of issues like reddishness of facial features, while retaining other aspects of enhanced color.

Although FIG. 15 illustrates one example of a semantic segmentation of pixels of the image in FIGS. 6 and 6A-6B analogous to FIG. 7, various changes may be made to FIG. 15. For example, the specific semantic segmentation of pixels can easily vary depending on the images being processed. Also, each image could have any suitable number of semantic classes. In addition, any suitable identifiers may be used to differentiate semantic classes.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompasses such changes and modifications as fall within the scope of the appended claims.

What is claimed is:

1. A method comprising:
obtaining, using at least one processing device of an electronic device, an image frame;
performing, using the at least one processing device, semantic segmentation of the image frame to generate semantic segmentation information for the image frame, the semantic segmentation information including an indexed image representing at least a first semantic class and a second semantic class; and
performing, using the at least one processing device, multi-scale local tone mapping of the indexed image using a first weight corresponding to the first semantic class and a second weight corresponding to the second semantic class;
wherein the first weight adapts enhancement of the image frame differently from the second weight based on a difference between the first semantic class and the second semantic class.

2. The method of claim 1, wherein performing the semantic segmentation comprises:
dividing an input luminance image corresponding to the image frame into multiple semantic classes including at least the first semantic class and the second semantic class;
applying a first bank of guided filters to the input luminance image to generate first base components and first detail components; and
applying a second bank of guided filters to the first base components to generate second base components and second detail components;
wherein enhancement of the image frame is performed by employing both the first weight corresponding to the first semantic class and the second weight corresponding to the second semantic class to adjust the first detail components and the second detail components.

3. The method of claim 2, wherein enhancement of the image frame comprises one of increasing or decreasing contributions of the first detail components and the second detail components to an enhanced image based on the first semantic class and the second semantic class.

4. The method of claim 3, wherein the enhanced image is determined based on:
$$x = {B}_{2} + {w}_{1} ( M ) \times {D}_{1}^{′} + {w}_{2} ( M ) \times {D}_{2}^{′} ,$$
where x represents the enhanced image, B₂ represents the second base components, M represents the indexed image, w₁ represents the first weight corresponding to the first detail component, w₂ represents the second weight corresponding to the second detail component,
$${D}_{1}^{′}$$
represents the first detail components enhanced based on the first semantic class and the second semantic class, and
$${D}_{2}^{′}$$
represents the second detail components enhanced based on the first semantic class and the second semantic class.

5. The method of claim 2, wherein sharpness and contrast are enhanced for the first detail components and the second detail components based on the first semantic class and the second semantic class.

6. The method of claim 2, wherein:
enhancement of the first detail components comprises detail enhancement and noise suppression; and
enhancement of the second detail components comprises detail enhancement and bright area negative detail enhancement.

7. The method of claim 2, wherein the enhancement of the first detail components and the second detail components employs a modulation function that maps each of the first semantic class and the second semantic class to a corresponding modulation strength and a function processing positive details and negative details symmetrically in order to boost or suppress details based on distance from a specified value.

8. The method of claim 7, wherein the modulation function Ss, (M) maps each of the first semantic class and the second semantic class to a modulation strength &1 applied to the first detail components, where M represents the indexed image as indexed based on the first semantic class and the second semantic class.

9. The method of claim 7, wherein the modulation function S_{δ}_{₂} (M) maps each of the first semantic class and the second semantic class to a modulation strength δ₂ applied to the second detail components, where M represents the indexed image as indexed based on the first semantic class and the second semantic class.

10. The method of claim 7, wherein the modulation function S_{σ}(M) maps each of the first semantic class and the second semantic class to a modulation strength τ applied to the first detail components as a smooth step function with first and second thresholds, where M represents the indexed image as indexed based on the first semantic class and the second semantic class.

11. The method of claim 1, wherein performing the semantic segmentation comprises:
dividing the image frame into multiple semantic classes including at least the first semantic class and the second semantic class;
applying first color processing to portions of the image frame corresponding to the first semantic class; and
applying second color processing to portions of the image frame corresponding to the second semantic class;
wherein color enhancement of the image frame is performed independently for colors of different semantic regions.

12. The method of claim 11, wherein:
the first color processing is associated with first hue shift or saturation boost values; and
the second color processing is associated with second hue shift or saturation boost values.

13. The method of claim 11, wherein the multiple semantic classes include semantic classes in addition to the first semantic class and the second semantic class.

14. An electronic device comprising:
at least one processing device configured to:
obtain an image frame;
perform semantic segmentation of the image frame to generate semantic segmentation information for the image frame, the semantic segmentation information including an indexed image representing at least a first semantic class and a second semantic class; and
perform multi-scale local tone mapping of the indexed image using a first weight corresponding to the first semantic class and a second weight corresponding to the second semantic class;
wherein the first weight adapts enhancement of the image frame differently from the second weight based on a difference between the first semantic class and the second semantic class.

15. The electronic device of claim 14, wherein, to perform the semantic segmentation, the at least one processing device is configured to:
divide an input luminance image corresponding to the image frame into multiple semantic classes including at least the first semantic class and the second semantic class;
apply a first bank of guided filters to the input luminance image to generate first base components and first detail components; and
apply a second bank of guided filters to the first base components to generate second base components and second detail components;
wherein the at least one processing device is configured to enhance the image frame based on both the first weight corresponding to the first semantic class and the second weight corresponding to the second semantic class to adjust the first detail components and the second detail components.

16. The electronic device of claim 15, wherein, to enhance the image frame, the at least one processing device is configured to one of increase or decrease contributions of the first detail components and the second detail components to an enhanced image based on the first semantic class and the second semantic class.

17. The electronic device of claim 16, wherein the at least one processing device is configured to generate the enhanced image based on:
$$x = {B}_{2} + {w}_{1} ( M ) \times {D}_{1}^{′} + {w}_{2} ( M ) \times {D}_{2}^{′} ,$$
where x represents the enhanced image, B₂ represents the second base components, M represents the indexed image, w₁ represents the first weight corresponding to the first detail component, w₂ represents the second weight corresponding to the second detail component,
$${D}_{1}^{′}$$
represents the first detail components enhanced based on the first semantic class and the second semantic class, and
$${D}_{2}^{′}$$
represents the second components enhanced based on the first semantic class and the second semantic class.

18. The electronic device of claim 15, wherein the at least one processing device is configured to enhance sharpness and contrast for the first detail components and the second detail components based on the first semantic class and the second semantic class.

19. The electronic device of claim 15, wherein:
the at least one processing device is configured to enhance the first detail components by providing detail enhancement and noise suppression; and
the at least one processing device is configured to enhance the second detail components by providing detail enhancement and bright area negative detail enhancement.

20. A non-transitory machine readable medium containing instructions that when executed cause at least one processor of an electronic device to:
obtain an image frame;
perform semantic segmentation of the image frame to generate semantic segmentation information for the image frame, the semantic segmentation information including an indexed image representing at least a first semantic class and a second semantic class; and
perform multi-scale local tone mapping of the indexed image using a first weight corresponding to the first semantic class and a second weight corresponding to the second semantic class;
wherein the first weight adapts enhancement of the image frame differently from the second weight based on a difference between the first semantic class and the second semantic class.
